(19) United States
(12) Patent Application Publication
(10) Pub. No.: US 2025/0050617 A1
(43) Pub. Date: Feb. 13, 2025

(54) COMPOSITE INSULATION BOARD

(71) Applicant: FIBREXT LLC, Cheyenne, WY (US)

(72) Inventors: Bill Shepard, ANACORTES, WA (US); Eric Singular, SANTA FE, NM (US); Matt Spencer, PALATINE, IL (US); Marc Lower, MELBOURNE BEACH, FL (US)

(21) Appl. No.: 18/784,696

(22) Filed: Jul. 25, 2024

Related U.S. Application Data
(60) Provisional application No. 63/515,770, filed on Jul. 26, 2023.
(60) Provisional application No. 63/515,722, filed on Jul. 26, 2023.

(51) Int. Cl. B32B 5/18; B29C 44/30; B29C 44/32; B29C 44/34; B29C 44/56; B29K 21/00; B29K 25/00; B29K 75/00; B29K 105/00; B29K 511/10; B29K 705/00; B29K 711/12; B29K 711/14; B29L 31/10; B32B 21/02; B32B 21/04; B32B 27/06; B32B 29/00; B32B 37/10; B32B 37/15; B32B 38/00

(52) U.S. Cl. CPC B32B 5/18; B29C 44/30; B29C 44/326; B29C 44/3442; B29C 44/56; B32B 21/02; B32B 21/047; B32B 27/065; B32B 29/007; B32B 37/10; B32B 37/15; B29K 2021/006; B29K 2025/06; B29K 2075/00; B29K 2105/0032; B29K 2511/10; B29K 2705/00; B29K 2711/12; B29K 2711/14; B29K 2995/0015; B29K 2995/0094; B29L 2031/10; B32B 2038/0084; B32B 2264/065; B32B 2264/303; B32B 2266/0214; B32B 2266/0228; B32B 2266/0278; B32B 2305/022; B32B 2307/304; B32B 2317/18; B32B 2325/00; B32B 2375/00; B32B 2607/00

(57) ABSTRACT

A low-carbon insulative foam board includes an agricultural product mixed with petroleum-derived polymer foam. The foam board exhibits insulation, durability, and mechanical properties substantially similar to a foam board without the mixed agricultural product. In an embodiment, a polyisocyanurate board includes bubble walls carrying milled biomass, which displaces a portion of the polyisocyanurate.

### CROSS REFERENCE TO RELATED APPLICATIONS

The present application claims priority benefit from U.S. Provisional Patent Application No. 63/515,770 entitled “COMPOSITE INSULATION BOARD”, filed Jul. 26, 2023 (Docket Number 3092-001-02); and claims priority benefit from U.S. Provisional Patent Application No. 63/515,722 entitled “IMPROVED RIGID INSULATION WITH SEQUESTERED CARBON”, filed Jul. 26, 2023 (Docket Number 3092-002-02); each of which, to the extent not inconsistent with the disclosure herein, is incorporated by reference.

### SUMMARY

Rigid foam insulation board is used in many applications for adding insulative value to wall, roof, foundation, and floor structures. Unfortunately, current rigid foam insulation board carries with it a high carbon footprint, in that the polymers used for making the foam are derived predominantly from crude oil. As disclosed herein, the inventors have discovered methods and materials wherein the foam precursor(s) may be combined with biomass such that a portion of the crude oil-derived material is displaced with a carbon-neutral or carbon-negative biomass material substantially without loss of insulative or mechanical properties. The mixing of a carbon-neutral or carbon-negative material with the polymer effectively sequesters atmospheric-derived carbon in the insulation board for the life of the structure. The inventors have found hemp hurd to be an especially desirable source of the biomass. Inventors contemplate additional biomass sources may be substituted for or mixed with the hemp hurd.

According to an embodiment, a method for making rigid insulation board having a low carbon footprint includes combining a cellulosic and/or biomass material with at least one insulative polymer foam precursor, distributing the at least one insulative polymer foam precursor, the biomass material, and a blowing agent between two webs of facing material, and conveying the two webs of material through a plurality of thickness rollers, presses. or via extrusion while at least one insulative polymer foam polymerizes and forms insulative polymer foam bubbles with the cellulosic material captured in walls of the insulative foam bubbles. The cellulosic material displaces a portion of the polymer, i.e., by including the cellulosic material with the polymer foam precursor, the amount of polymer foam precursor necessary to produce a given volume of insulative foam is reduced.

According to an embodiment, an insulative foam board includes foamed polyisocyanurate with 5% to 30% 3 millimeter or less biomass particles suspended in bubble walls, a first facing layer on one surface of the foamed polyisocyanurate, and a second facing layer on a second surface of the foamed polyisocyanurate. The 3 millimeter or less biomass particles may include about 2 millimeter biomass particles. The biomass particles may include hemp hurd.

### BRIEF DESCRIPTION OF THE DRAWINGS

FIG. 1 is a diagram of a method for making composite insulation board having a low carbon footprint, according to an embodiment.

FIG. 2 is a diagram of a composite insulation board having a low carbon footprint, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

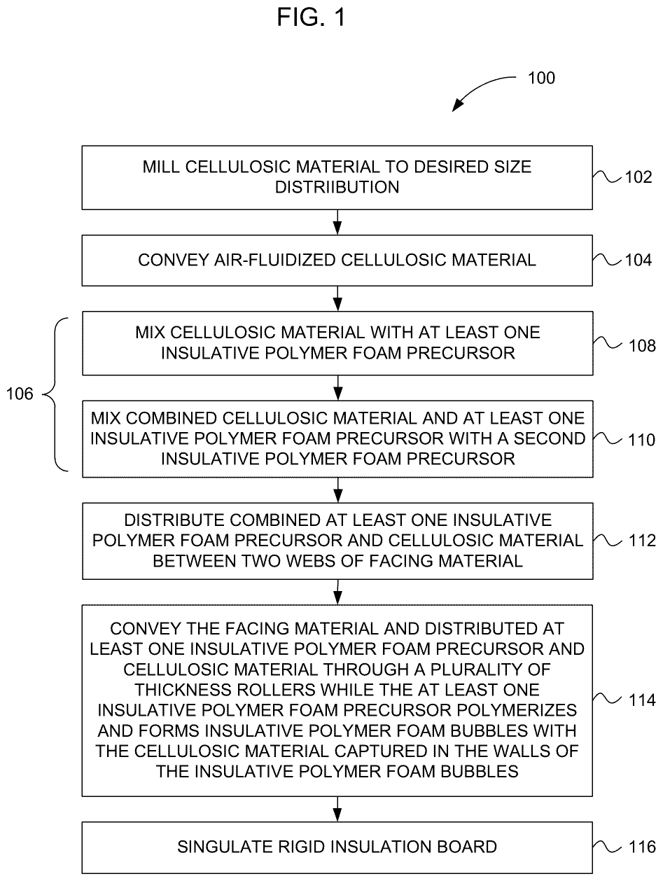

FIG. 1 is a diagram of a method 100 for making composite insulation board having a low carbon footprint, according to an embodiment. The method 100 for making rigid insulation board having a low carbon footprint includes, in step 108, combining a cellulosic material with at least one insulative polymer foam precursor, in step 112, distributing the at least one insulative polymer foam precursor, the cellulosic material, and a blowing agent between two webs of facing material; and, in step 114, conveying the two webs of material through a plurality of thickness rollers, presses of via extrusion while the at least one insulative polymer foam precursor polymerizes and forms insulative polymer foam bubbles with the cellulosic material captured in walls of the insulative foam bubbles. The cellulosic material displaces a portion of the polymer.

The method 100 may further include, in step 116, singulating the resultant rigid insulation board to a specified size. One of webs of facing material may include a plurality of singulated flat material, such as oriented strand board.

The polymer may include polyisocyanurate. Accordingly, the at least one insulative polymer foam precursor may include a first and a second polyisocyanurate precursors. The first and second polyisocyanurate precursors may include methylene diphenyl diisocyanate (MDI) and a polyester-derived polyol. The first and second polyisocyanurate precursors may trimerize with gas evolution to form isocyanurate groups linked by polyols with suspended cellulosic material in foam walls between the two webs of facing material.

The cellulosic material may include hemp. For example, the cellulosic material may consist essentially of biomass.

The cellulosic material may include a material milled through a 3 millimeter or smaller sieve.

The method 100 may further include, in step 102, milling the hemp hurd. As shown in step 104, the method 100 may include conveying the cellulosic material in air-fluidized form to mix with the at least one insulative polymer foam precursor.

According to an embodiment, combining the cellulosic material with at least one insulative polymer foam precursor in step 106 includes, in step 108 first mixing the cellulosic material with methylene diphenyl diisocyanate (MDI); and, in step 110, mixing the combined cellulosic material and MDI with a polyester-derived polyol. In another embodiment, the cellulosic material, methylene diphenyl diisocyanate (MDI), and polyester-derived polyol are mixed in a single mixing stage.

Combining the cellulosic material with the at least one insulative polymer foam precursor may include combining two insulative polymer foam precursors and cellulosic material with a high-shear mixer in a single step. Combining the cellulosic material with the at least one insulative polymer foam precursor may include combining the cellulosic material, the at least one insulative polymer foam precursor, and a colorant. Combining the cellulosic material with the at least one insulative polymer foam precursor may include combining the cellulosic material, the at least one insulative polymer foam precursor, and a fire retardant.

Step 114, conveying the two webs of material through a plurality of thickness rollers while at least one insulative polymer foam polymerizes and forms insulative polymer foam bubbles with the cellulosic material captured in walls of the insulative foam bubbles may include conveying the two webs of material through a plurality of thickness rollers while polyisocyanurate precursors trimerize in the presence of the blowing agent to form isocyanurate groups linked by polyols with suspended biomass in foam walls between the two webs of facing material. The cellulosic material displaces a portion of polyisocyanurate in the foam walls.

Distributing the blowing agent between the two webs of facing material may include coating at least one of the webs of facing material with a liquid or solid blowing agent selected to vaporize at a polymerization temperature. Distributing the blowing agent between the two webs of facing material may include coating at least one of the webs of facing material with pentane prior to distributing the at least one insulative polymer foam precursor and the cellulosic material.

Distributing the polyisocyanurate precursors and the cellulosic material between two webs of facing material may include distributing the polyisocyanurate precursors and the cellulosic material at a predetermined surface loading selected according to a desired finished rigid insulation board thickness and/or insulation R-value.

According to other embodiments, the polymer includes polystyrene or polyurethane.

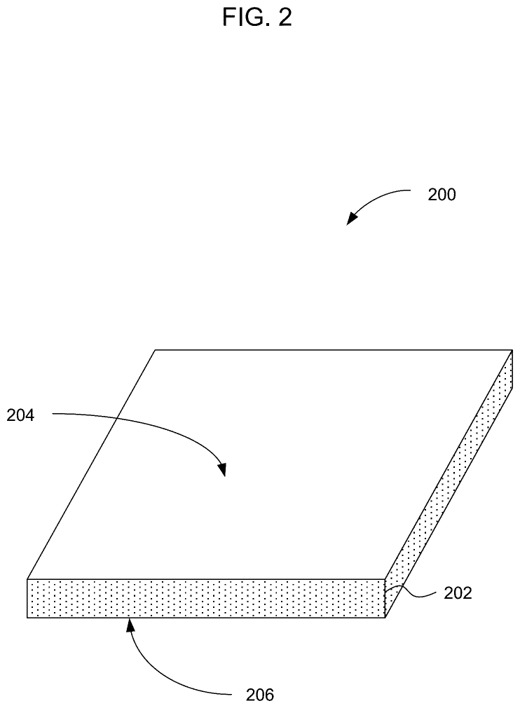

FIG. 2 is a diagram of a composite insulation board 200, according to an embodiment. The insulative foam board 200 may include foamed polyisocyanurate with 5% to 30% 3 millimeter or smaller biomass particles suspended in bubble walls 202; a first facing layer 204 on one surface of the foamed polyisocyanurate; and a second facing layer 206 on a second surface of the foamed polyisocyanurate. In an embodiment, the 3 millimeter or smaller biomass particles may include 3 millimeter or smaller hemp hurd particles. In an embodiment, the 3 millimeter or smaller biomass particles may include 2 millimeter biomass particles.

The first facing layer 204 and the second facing layer 206 may be the same material.

In an embodiment, at least one of the first facing layer 204 and the second facing layer 206 includes oriented strand board (OSB).

In an embodiment, at least one of the first facing layer 204 and the second facing layer 206 includes paper. In an embodiment, at least one of the first facing layer 204 and the second facing layer 206 includes a polymer film. In an embodiment, at least one of the first facing layer 204 and the second facing layer 206 includes a foil or metallized polymer film.

In an embodiment, the foamed polyisocyanurate with 5% to 30% 3millimeter or smaller biomass particles suspended in bubble walls 202 includes 15% to 30% biomass wt./wt. For example, the foamed polyisocyanurate with 55% to 30% wt./wt. 3 millimeter or smaller biomass particles suspended in bubble walls may include 5% to 25% biomass wt./wt. The foamed polyisocyanurate with 5% to 30% wt./wt. 3 millimeter or smaller biomass particles may include 15% to 25% biomass wt./wt. The foamed polyisocyanurate with 5% to 30% wt./wt. 3 millimeter or smaller biomass particles may include 18% to 22% biomass wt./wt.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A method for making rigid insulation board having a low carbon footprint, comprising:
combining a biomass material with at least one insulative polymer foam precursor;
distributing the at least one insulative polymer foam precursor, the biomass material, and a blowing agent between two webs of facing material; and
conveying the two webs of material through a plurality of thickness rollers presses, or via extrusion while the at least one insulative polymer foam precursor polymerizes and forms insulative polymer foam bubbles with the biomass material captured in walls of the insulative foam bubbles;
wherein the biomass material displaces a portion of the polymer.

2. The method for making the rigid insulation board of claim 1, further comprising:
singulating a resultant rigid insulation board to a specified size.

3. The method for making the rigid insulation board of claim 1, wherein one of the webs of facing material includes a plurality of singulated flat material.

4. The method for making the rigid insulation board of claim 1, wherein the polymer includes polyisocyanurate.

5. The method for making the rigid insulation board of claim 4, wherein the at least one insulative polymer foam precursor includes a first and a second polyisocyanurate precursor.

6. (canceled)

7. The method for making the rigid insulation board of claim 5, wherein the first and second polyisocyanurate precursors trimerize with gas evolution to form isocyanurate groups linked by polyols with suspended cellulosic material in foam walls between the two webs of facing material.

8. The method for making the rigid insulation board of claim 1, wherein the biomass material comprises hemp.

9. The method for making the rigid insulation board of claim 8, wherein the biomass material consists essentially of hemp hurd.

10.-13. (canceled)

14. The method for making the rigid insulation board of claim 1, wherein combining the cellulosic material with the at least one insulative polymer foam precursor includes combining two insulative polymer foam precursors and cellulosic material with a high-shear mixer in a single step.

15.-16. (canceled)

17. The method for making the rigid insulation board of claim 1, wherein conveying the two webs of material through a plurality of thickness rollers while the at least one insulative polymer foam precursor polymerizes and forms insulative polymer foam bubbles with the cellulosic material captured in walls of the insulative foam bubbles includes:
conveying the two webs of material through a plurality of thickness rollers while polyisocyanurate precursors trimerize in the presence of the blowing agent to form isocyanurate groups linked by polyols with suspended cellulosic material in foam walls between the two webs of facing material; and
wherein the cellulosic material displaces a portion of polyisocyanurate in the foam walls.

18.-19. (canceled)

20. The method for making the rigid insulation board of claim 1, wherein distributing the at least one insulative polymer foam precursor and the cellulosic material between two webs of facing material includes distributing polyisocyanurate precursors and the cellulosic material at a predetermined surface loading selected according to a desired finished rigid insulation board thickness and/or insulation R-value.

21.-22. (canceled)

23. An insulative foam board, comprising:
foamed polyisocyanurate with 5% to 30% 3 millimeter or smaller biomass particles suspended in bubble walls; and
a first facing layer on one surface of the foamed polyisocyanurate; and
a second facing layer on a second surface of the foamed polyisocyanurate.

24. The insulative foam board of claim 23, wherein the first facing layer and the second facing layer are the same material.

25. (canceled)

26. The insulative foam board of claim 23, wherein the material of at least one of the first facing layer and the second facing layer includes paper.

27. The insulative foam board of claim 23, wherein the material of at least one of the first facing layer and the second facing layer includes a polymer film.

28. The insulative foam board of claim 23, wherein the material of at least one of the first facing layer and the second facing layer includes a foil or metallized polymer film.

29. The insulative foam board of claim 23, wherein the foamed polyisocyanurate with 5% to 30% 3 millimeter or smaller biomass particles suspended in bubble walls includes 15% to 30% biomass wt./wt.

30.-31. (canceled)

32. The insulative foam board of claim 29, wherein the foamed polyisocyanurate with 15% to 30% wt./wt. 3 millimeter or smaller biomass particles includes 18% to 22% hemp hurd wt./wt.

33. The insulative foam board of claim 23, wherein the 3 millimeter or smaller biomass particles include 3 millimeter or smaller hemp hurd particles.

34. The insulative foam board of claim 23, wherein the 3 millimeter or smaller biomass particles comprise 2 millimeter biomass particles.
